(19) United States
(12) Patent Application Publication
(10) Pub. No.: US 2024/0407463 A1
(43) Pub. Date: Dec. 12, 2024

(54) AEROSOL GENERATING DEVICE AND METHOD OF OPERATING THE SAME

(71) Applicant: KT&G CORPORATION, Daejeon (KR)

(72) Inventors: Jongsub LEE, Sungnam-si, Gyeonggi-do (KR); Sangkyu PARK, Seoul (KR); Wooseok CHUNG, Namyangju-si, Gyeonggi-do (KR); Byungsung CHO, Gwangmyung-si, Gyeonggi-do (KR); Daenam HAN, Seoul (KR)

(73) Assignee: KT&G CORPORATION, Daejeon (KR)

(21) Appl. No.: 18/698,312

(22) PCT Filed: Oct. 12, 2022
(86) PCT No.: PCT/KR2022/015428

§ 371 Date: Apr. 3, 2024

(30) Foreign Application Priority Data
Oct. 19, 2021 (KR) 10-2021-0139794
Feb. 22, 2022 (KR) 10-2022-0023261

(51) Int. Cl. A24F 40/57; A24F 40/20; A24F 40/51; A24F 40/60; A24F 40/65

(52) U.S. Cl. CPC A24F 40/57; A24F 40/20; A24F 40/51; A24F 40/60; A24F 40/65

(57) ABSTRACT

An aerosol generating device and a method of operating the same are provided. The aerosol generating device includes: a container sized to receive an aerosol generating substance; a heater to heat the aerosol generating substance; a first sensor to detect a puff; and a controller configured to: control power supplied to the heater; identify an elapsed time between a first puff and a second puff, based on the first sensor detecting the first puff and detecting the second puff, wherein the second puff occurs after the first puff; compare the elapsed time with a first time threshold; control first power to be supplied to the heater, based on the elapsed time being less than the first time threshold; and control second power to be supplied to the heater, based on the elapsed time being greater than or equal to the first time threshold, wherein the second power is higher than the first power.

### TECHNICAL FIELD

The present disclosure relates to an aerosol generating device and a method of operating the same.

### BACKGROUND ART

An aerosol generating device is a device that extracts certain components from a medium or a substance by producing an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol generating devices has been conducted.

### DISCLOSURE

### Technical Problem

It is an objective of the present disclosure to solve the above and other problems.

It is another objective of the present disclosure to provide an aerosol generating device that can prevent a reduction in amount of aerosol generated, which is due to liquid leakage from a cartridge when the cartridge for storing an aerosol generating substance is used again after a long period of non-use, and a method of operating the same.

It is yet another objective of the present disclosure to provide an aerosol generating device that can effectively suppress a reduction in amount of aerosol generated by controlling the amount of power supplied to a heater to be proportional to a time during which a cartridge is left unused, and a method of operating the same.

It is yet another objective of the present disclosure to provide an aerosol generating device that can effectively suppress a reduction in amount of aerosol generated by controlling the amount of power for preheating a heater to be proportional to a time during which a cartridge is left unused, and a method of operating the same.

It is yet another objective of the present disclosure to provide an aerosol generating device that can minimize the sense of difference or discomfort that a user may feel by gradually changing or adjusting the amount of power supplied to a heater, and a method of operating the same.

### Technical Solution

According to one aspect of the subject matter described in this application, an aerosol generating device includes: a container sized to receive an aerosol generating substance; a heater configured to heat the aerosol generating substance; a first sensor to detect a puff; and a controller configured to: control power supplied to the heater, identify an elapsed time between a first puff and a second puff, based on the first sensor detecting the first puff and detecting the second puff, wherein the second puff occurs after the first puff; compare the elapsed time with a first time threshold; control first power to be supplied to the heater, based on the elapsed time being less than the first time threshold; and control second power to be supplied to the heater, based on the elapsed time being greater than or equal to the first time threshold, wherein the second power is higher than the first power.

According to another aspect of the subject matter described in this application, a method for operating an aerosol generating device having a heater is provided. The method includes: identifying an elapsed time between a first puff and a second puff, based on a sensor detecting the first puff and detecting the second puff, wherein the second puff occurs after the first puff; comparing the elapsed time with a first time threshold; controlling first power to be supplied to the heater, based on the elapsed time being less than the first time threshold; and controlling second power to be supplied to the heater, based on the elapsed time being greater than or equal to the first time threshold, wherein the second power is higher than the first power.

### Advantageous Effects

According to at least one of the embodiments of the present disclosure, a reduction in amount of aerosol generated due to liquid leakage from a cartridge may be prevented when the cartridge for storing an aerosol generating substance is used again after a long period of non-use.

According to at least one of the embodiments of the present disclosure, as the amount of power supplied to a heater is controlled to be proportional to a time during which a cartridge is left unused, a reduction in amount of aerosol generated may be efficiently suppressed.

According to at least one of the embodiments of the present disclosure, as the amount of power for preheating a heater is controlled to be proportional to a time during which a cartridge is left unused, a reduction in amount of aerosol generated may be efficiently suppressed.

According to at least one of the embodiments of the present disclosure, the sense of difference or discomfort that a user may feel may be minimized by gradually changing or adjusting the amount of power supplied to a heater.

The additional scope of applicability of the present disclosure will be apparent from the following detailed description. However, those skilled in the art will appreciate that various modifications and alterations are possible, without departing from the idea and scope of the present disclosure, and therefore it should be understood that the detailed description and specific embodiments, such as the preferred embodiments of the present disclosure, are provided only for illustration.

### DESCRIPTION OF DRAWINGS

FIG. 1 is a block diagram illustrating an example of an aerosol generating device.

FIGS. 2 to 4 are views referenced to describe examples of an aerosol generating device.

FIGS. 5 to 7 are views referenced to describe examples of a stick.

FIG. 8 is a flowchart illustrating an exemplary method of operating an aerosol generating device.

FIGS. 9 to 11 are views illustrating examples of the method of FIG. 8.

FIGS. 12, 14, and 16 are flowcharts respectively illustrating an exemplary method of operating an aerosol generating device.

FIGS. 13, 15, and 17 are views illustrating examples of the methods of FIGS. 12, 14, and 16, respectively.

### [Best Mode]

Description will now be given in detail according to exemplary embodiments disclosed herein, with reference to the accompanying drawings. For the sake of brief description with reference to the drawings, the same or equivalent components are provided with the same or similar reference numerals, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms “first”, “second”, etc. may be used herein to describe various elements, these elements should not be limited by these terms. These terms are only used to distinguish one element from another.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, a singular representation is intended to include a plural representation unless the context clearly indicates otherwise.

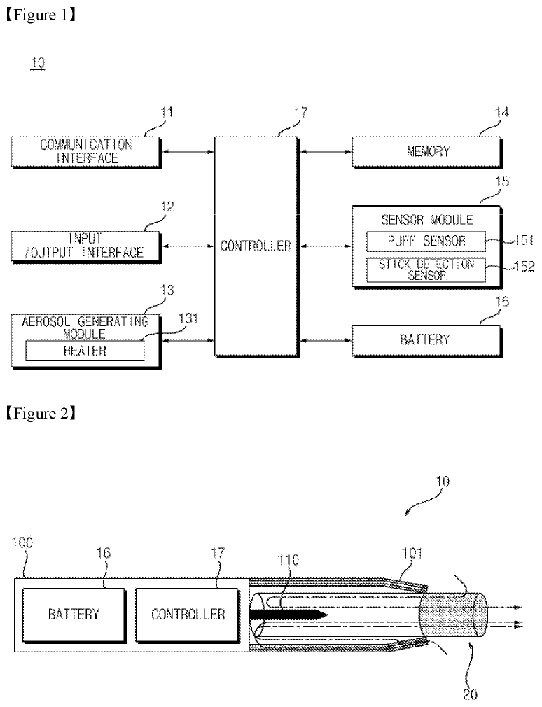

FIG. 1 is a block diagram of an aerosol generating device according to an embodiment of the present disclosure.

Referring to FIG. 1, an aerosol generating device 10 may include a communication interface 11, an input/output interface 12, an aerosol generating module 13, a memory 14, a sensor module 15, a battery 16, and/or a controller 17.

In one embodiment, the aerosol generating device 10 may consist of only a body 100. In this case, components included in the aerosol generating device 10 may be disposed in the body 100. In another embodiment, the aerosol generating device 10 may consist of a cartridge 200, which contains an aerosol generating substance, and a body 100. In this case, components included in the aerosol generating device 10 may be disposed in at least one of the body 100 and the cartridge 200.

The communication interface 11 may include at least one communication module for communication with an external device and/or a network. For example, the communication interface 11 may include a communication module for wired communication such as a Universal Serial Bus (USB). For example, the communication interface 11 may include a communication module for wireless communication such as Wireless Fidelity (Wi-Fi), Bluetooth, Bluetooth Low Energy (BLE), ZigBee, or Near-Field Communication (NFC).

The input/output interface 12 may include an input device for receiving a command from a user and/or an output device for outputting information to the user. For example, the input device may include a touch panel, a physical button, a microphone, etc. For example, the output device may include a display device for outputting visual information, such as a display or a light-emitting diode (LED), an audio device for outputting auditory information, such as a speaker or a buzzer, a motor for outputting tactile information, such as a haptic effect, etc.

The input/output interface 12 may transmit data corresponding to a command input by the user through the input device to another component (or other components) of the aerosol generating device 10. The input/output interface 12 may output information corresponding to data received from another component (or other components) of the aerosol generating device 10 through the output device.

The aerosol generating module 13 may generate an aerosol from an aerosol generating substance. Here, the aerosol generating substance may be a substance in a liquid state, a solid state, or a gel state, which can produce an aerosol, or a combination of two or more aerosol generating substances.

In one embodiment, the liquid aerosol generating substance may be a liquid including a tobacco-containing material having a volatile tobacco flavor component. In another embodiment, the liquid aerosol generating substance may be a liquid including a non-tobacco material. For example, the liquid aerosol generating substance may include water, solvents, nicotine, plant extracts, flavorings, flavoring agents, vitamin mixtures, etc.

The solid aerosol generating substance may include a solid material based on a tobacco raw material such as a reconstituted tobacco sheet, shredded tobacco, or granulated tobacco. In addition, the solid aerosol generating substance may include a solid material having a taste control agent and a flavoring material. For example, the taste control agent may include calcium carbonate, sodium bicarbonate, calcium oxide, etc. For example, the flavoring material may include a natural material such as herbal granules, or may include a material such as silica, zeolite, or dextrin, which includes an aroma ingredient.

In addition, the aerosol generating substance may further include an aerosol forming agent such as glycerin or propylene glycol.

The aerosol generating module 13 may include at least one heater 131.

The aerosol generating module 13 may include an electro-resistive heater. For example, the electro-resistive heater may include at least one electrically conductive track. The electro-resistive heater may be heated by the current flowing through the electrically conductive track. Here, the aerosol generating substance may be heated by the heated electro-resistive heater.

The electrically conductive track may include an electro-resistive material. In one example, the electrically conductive track may be formed of a metal material. In another example, the electrically conductive track may be formed of a ceramic material, carbon, a metal alloy, or a composite of a ceramic material and metal.

The electro-resistive heater may include an electrically conductive track that is formed in any of various shapes. For example, the electrically conductive track may have any one of a tubular shape, a plate shape, a needle shape, a rod shape, and a coil shape.

The aerosol generating module 13 may include a heater that uses an induction-heating method, namely, an induction heater. For example, the induction heater may include an electrically conductive coil. The induction heater may generate an alternating magnetic field, which periodically changes in direction, by adjusting the current flowing through the electrically conductive coil. In this case, when the alternating magnetic field is applied to a magnetic body, energy loss may occur in the magnetic body due to eddy current loss and hysteresis loss, and the lost energy may be released as thermal energy. Accordingly, the aerosol generating substance located adjacent to the magnetic body may be heated. Here, an object that generates heat due to the magnetic field may be referred to as a susceptor.

Meanwhile, the aerosol generating module 13 may generate ultrasonic vibrations to thereby produce an aerosol from the aerosol generating substance.

The aerosol generating module 13 may be referred to as a cartomizer, an atomizer, or a vaporizer.

When the aerosol generating device 10 consists of a cartridge 200 containing an aerosol generating substance, and a body 100, the aerosol generating module 13 may be disposed in at least one of the body 100 and the cartridge 200.

The memory 14 may store therein a program for processing and controlling each signal in the controller 17. The memory 14 may store therein processed data and data to be processed.

For example, the memory 14 may store therein applications designed for the purpose of performing various tasks that can be processed by the controller 17. For example, the memory 14 may selectively provide some of the stored applications in response to a request from the controller 17.

For example, the memory 14 may store therein data regarding an operation time of the aerosol generating device 10, the maximum number of puffs, the current number of puffs, at least one temperature profile, and a user's inhalation pattern. Here, the “puff(s)” may refer to inhalation by a user, and the “inhalation” may refer to the user's act of taking air or other substances into the user's oral cavity, nasal cavity, or lungs through the user's mouth or nose.

The memory 14 may include at least one of volatile memory (e.g., dynamic random access memory (DRAM), static random access memory (SRAM), and synchronous dynamic random access memory (SDRAM)), nonvolatile memory (e.g., flash memory), a hard disk drive (HDD), and a solid-state drive (SSD).

The memory 14 may be disposed in at least one of the body 100 and the cartridge 200. The memory 14 may be disposed in each of the body 100 and the cartridge 200. For example, a memory of the body 100 may store information regarding components disposed in the body 100, namely, information regarding the full charge capacity of the battery 16. For example, the memory of the body 100 may store cartridge information received from the cartridge 200 previously or currently coupled to the body 100, and a memory of the cartridge 200 may store cartridge information including cartridge identification information (ID information), a cartridge type, and the like.

The sensor module 15 may include at least one sensor.

For example, the sensor module 15 may include a sensor for sensing a puff (hereinafter referred to as a “puff sensor” 151). Here, the puff sensor 151 may be implemented as a proximity sensor such as an IR sensor, a pressure sensor, a gyro sensor, an acceleration sensor, a magnetic field sensor, or the like.

For example, the sensor module 15 may include a sensor for sensing a temperature of the heater 131 included in the aerosol generating module 13 and a temperature of the aerosol generating substance (hereinafter referred to as a “temperature sensor”).

In this case, the heater 131 included in the aerosol generating module 13 may also serve as the temperature sensor. For example, the electro-resistive material of the heater 131 may be a material having a temperature coefficient of resistance (TCR). The sensor module 15 may measure resistance of the heater 131, which varies according to temperature, to thereby sense the temperature of the heater 131.

For example, when a stick is capable of being inserted into the body 100 of the aerosol generating device 10 and/or the cartridge 200, the sensor module 15 may include a sensor for sensing insertion of the stick (hereinafter referred to as a “stick detection sensor” 152).

For example, when the aerosol generating device 10 includes a cartridge 200, the module 15 may include a sensor for sensing mounting/removal (or sensor attachment/detachment) of the cartridge 200 to/from the body 100 and a position of the cartridge 200 (hereinafter referred to as a “cartridge detection sensor”).

In this case, the stick detection sensor 152 and/or the cartridge detection sensor may be implemented as an inductance-based sensor, a capacitance sensor, a resistance sensor, or a Hall sensor using a Hall effect. In some embodiments, the cartridge detection sensor may include a connection terminal. The connection terminal may be provided in the body 100. As the cartridge 200 is be coupled to the body 100, the connection terminal may be electrically connected to electrodes disposed in the cartridge 200. The connection terminal may serve as the cartridge detection sensor. For example, the sensor module 15 may detect mounting/removal of the cartridge 200 to/from the body 100 based on a current flowing in the connection terminal, a voltage applied to the connection terminal, or the like.

For example, the sensor module 15 may include a voltage sensor for sensing a voltage applied to a component (e.g., the battery 16) provided in the aerosol generating device 10 and/or a current sensor for sensing a current.

For example, the sensor module 15 may include at least one sensor for sensing the movement of the aerosol generating device 10 (hereinafter referred to as a “motion sensor”). Here, the motion sensor may be implemented as at least one of a gyro sensor and an acceleration sensor.

The battery 16 may supply power used for the operation of the aerosol generating device 10 under the control of the controller 17. The battery 16 may supply power to other components provided in the aerosol generating device 10. For example, the battery 16 may supply power to the communication module included in the communication interface 11, the output device included in the input/output interface 12, and the heater 131 included in the aerosol generating module 13.

The battery 16 may be a rechargeable battery or a disposable battery. For example, the battery 16 may be a lithium-ion battery or a lithium polymer (Li-polymer) battery, but is not limited thereto. For example, when the battery 16 is rechargeable, a charge rate (C-rate) of the battery 16 may be 10 C, and a discharge rate (C-rate) thereof may be 10 C to 20 C. However, the present disclosure is not limited thereto. In addition, for stable use, the battery 16 may be designed to retain 80% or more of its original capacity at 2,000 full charge and discharge cycles.

The aerosol generating device 10 may further include a battery protection circuit module (PCM), which is a circuit for protecting the battery 16. The battery protection circuit module (PCM) may be disposed adjacent to an upper surface of the battery 16. For example, in order to prevent overcharging and overdischarging of the battery 16, the battery protection circuit module (PCM) may cut off an electrical path to the battery 16 when a short circuit occurs in a circuit connected to the battery 16, when an overvoltage is applied to the battery 16, or when an excessive current flows through the battery 16.

The aerosol generating device 10 may further include a charging terminal to which power supplied from the outside is input. For example, the charging terminal may be provided at one side of the body 100 of the aerosol generating device 10. The aerosol generating device 10 may charge the battery 16 using the power supplied through the charging terminal. In this case, the charging terminal may be configured as a wired terminal for USB communication, a pogo pin, or the like.

The aerosol generating device 10 may wirelessly receive power supplied from the outside through the communication interface 11. For example, the aerosol generating device 10 may wirelessly receive power using an antenna included in the communication module for wireless communication. For example, the aerosol generating device 10 may charge the battery 16 using the wirelessly supplied power.

The controller 17 may control the overall operation of the aerosol generating device 10. The controller 17 may be connected to each of the components provided in the aerosol generating device 10. The controller 17 may transmit and/or receive a signal to and/or from each of the components, thereby controlling the overall operation of each of the components. The controller 17 may include at least one processor. The controller 17 may control the overall operation of the aerosol generating device 10 through the processor included therein. Here, the processor may be a general processor such as a central processing unit (CPU). Alternatively, the processor may be a dedicated device such as an application-specific integrated circuit (ASIC) or any of other hardware-based processors.

The controller 17 may perform any one of a plurality of functions of the aerosol generating device 10. For example, the controller 17 may perform any one of a plurality of functions of the aerosol generating device 10 (e.g., a preheating function, a heating function, a charging function, and a cleaning function) according to the state of each of the components provided in the aerosol generating device 10, a user command received through the input/output interface 12, and the like.

The controller 17 may control the operation of each of the components provided in the aerosol generating device 10 based on data stored in the memory 14. For example, the controller 17 may control such that predetermined power is supplied from the battery 16 to the aerosol generating module 13 for a predetermined time based on data stored in the memory 14 such as the temperature profile and the user's inhalation pattern.

The controller 17 may determine the occurrence or non-occurrence of a puff through the puff sensor 151 included in the sensor module 15. For example, the controller 17 may check a temperature change, a flow change, a pressure change, and a voltage change in the aerosol generating device 10 based on values sensed by the puff sensor 151. For example, the controller 17 may determine the occurrence or non-occurrence of a puff according to the result of checking based on a value sensed by the puff sensor 151.

The controller 17 may control the operation of each of the components provided in the aerosol generating device 10 according to the occurrence or non-occurrence of a puff and/or the number of puffs. For example, the controller 17 may control the temperature of the heater 131 to be changed or maintained based on the temperature profile stored in the memory 14.

The controller 17 may control such that the supply of power to the heater 131 is interrupted according to a predetermined condition. For example, the controller 17 may control such that the supply of power to the heater 131 is cut off when a stick is removed, when the cartridge 200 is removed from the body 100, when the number of puffs reaches the predetermined maximum number of puffs, when a puff is not sensed for a predetermined time or longer, or when the remaining capacity of the battery 16 is less than a predetermined value.

The controller 17 may calculate the remaining capacity with respect to the full charge capacity of the battery 16. For example, the controller 17 may calculate the remaining capacity of the battery 16 based on a value sensed by the voltage sensor and/or the current sensor included in the sensor module 15.

The controller 17 may control such that power is supplied to the heater 131 using at least one of a pulse width modulation (PWM) method and a proportional-integral-differential (PID) method.

For example, the controller 17 may control such that a current pulse having a predetermined frequency and a predetermined duty ratio is supplied to the heater 131 using the PWM method. In this case, the controller 17 may control power supplied to the heater 131 by adjusting the frequency and the duty ratio of the current pulse.

For example, the controller 17 may determine a target temperature to be controlled based on the temperature profile. In this case, the controller 17 may control power supplied to the heater 131 using the PID method, which is a feedback control method using a difference value between the temperature of the heater 131 and the target temperature, a value obtained by integrating the difference value with respect to time, and a value obtained by differentiating the difference value with respect to time.

For example, the controller 17 may control power supplied to the heater 131 based on the temperature profile. The controller 17 may control a length of a heating section for heating the heater 131, the amount of power supplied to the heater 131 in the heating section, and the like. The controller 17 may control power supplied to the heater 131 based on the target temperature of the heater 131.

Although the PWM method and the PID method are described as exemplary methods of controlling the supply of power to the heater 131, the present disclosure is not limited thereto. Other various control methods, such as a proportional-integral (PI) method and a proportional-differential (PD) method, may also be used.

The controller 17 may determine a temperature of the heater 131, and may adjust the amount of power supplied to the heater 131 according to the temperature of the heater 131. For example, the controller 17 may determine the temperature of the heater 131 by checking a resistance value of the heater 131, a current flowing through the heater 131, and/or a voltage applied to the heater 131.

Meanwhile, the controller 17 may control such that power is supplied to the heater 131 according to a predetermined condition. For example, when a cleaning function for cleaning a space into which a stick is inserted is selected according to a command input by the user through the input/output interface 12, the controller 17 may control such that predetermined power is supplied to the heater 131.

FIGS. 2 to 4 are views for explaining an aerosol generating device according to embodiments of the present disclosure.

According to various embodiments of the present disclosure, the aerosol generating device 10 may include a body 100 and/or a cartridge 200.

Referring to FIG. 2, the aerosol generating device 10 according to this embodiment may include a body 100 configured to allow a stick 20 to be inserted into a space defined by a housing 101 thereof.

The stick 20 may be similar to a typical combustible cigarette. For example, the stick 20 may be divided into a first part including an aerosol generating substance and a second part including a filter and the like. Alternatively, the second part of the stick 20 may also include an aerosol generating substance. For example, an aerosol generating substance made in the form of granules or capsules may be inserted into the second part.

The entire first part may be inserted into the aerosol generating device 10, and the second part may be exposed to the outside. Alternatively, only a portion of the first part may be inserted into the aerosol generating device 10, or portions of the first part and the second part may be inserted into the aerosol generating device 10. A user may inhale an aerosol while holding the second part in his or her mouth. As outside or external air passes through the first part, an aerosol may be generated, and the generated aerosol may pass through the second part to be delivered to the mouth of the user.

The body 100 may have a structure that allows external air to be introduced therein with the stick 20 inserted. Here, the external air introduced into the body 100 may pass through the stick 20 to flow into the mouth of the user.

A heater may be disposed in the body 100 corresponding to a position of the stick 20 when being inserted into the body 100. Although the heater in FIG. 2 is illustrated as an electrically conductive heater 110 including an electrically conductive track of a needle-shape, the present disclosure is not limited thereto.

The heater may heat an inside and/or outside of the stick 20 by using power supplied from the battery 16. In this case, an aerosol may be generated in the heated stick 20. Here, the user may puff on one end of the stick 20 with his or her mouth to inhale a tobacco-flavored aerosol.

Meanwhile, according to a predetermined condition, the controller 17 may control such that power is supplied to the heater even when the stick 20 is not inserted into the body 100. For example, when a cleaning function for cleaning the space into which the stick 20 is inserted is selected according to a command input by the user through the input/output interface 12, the controller 17 may control predetermined power to be supplied to the heater.

The controller 17 may monitor the number of puffs upon insertion of the stick 20 into the body 10 based on a value sensed by the puff sensor 151.

When the inserted stick 20 is removed from the body 100, the controller 17 may initialize the current number of puffs stored in the memory 14.

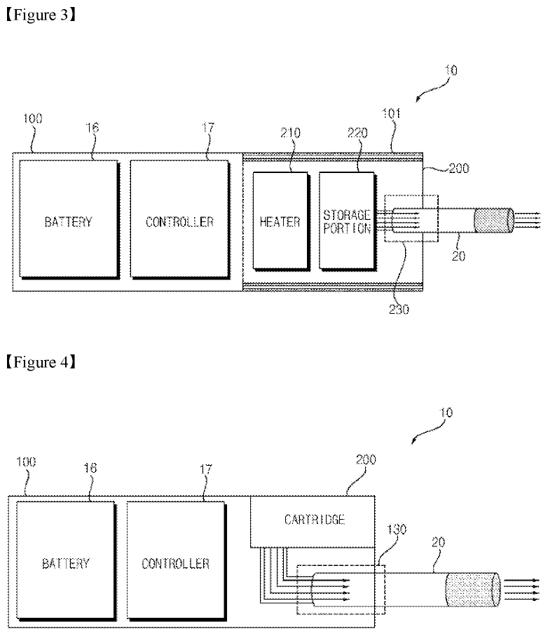

Referring to FIG. 3, the aerosol generating device 10 according to this embodiment may include a body 100 that supports a cartridge 200 and the cartridge 200 that contains an aerosol generating substance.

In one embodiment, the cartridge 200 may be configured to be detachably attached to the body 100. In another embodiment, the cartridge 200 may be integrally formed with the body 100. For example, at least a portion of the cartridge 200 may be inserted into an inner space defined by a housing 101 of the body 100, allowing the cartridge 200 to be mounted to the body 100.

The body 100 may have a structure that allows external air to be introduced therein with the cartridge 200 inserted. Here, the external air introduced into the body 100 may pass through the cartridge 200 to flow into the mouth of the user.

The controller 17 may determine mounting/removal of the cartridge 200 to/from the body 100 through the cartridge detection sensor included in the sensor module 15. For example, the cartridge detection sensor may transmit a pulse current through one terminal connected to the cartridge 200. In this case, the cartridge detection sensor may detect connection or disconnection of the cartridge 200 based on whether the pulse current is received through another terminal.

The cartridge 200 may include a heater 210 that heats an aerosol generating substance and/or a storage portion 220 that stores the aerosol generating substance. For example, a liquid delivery element impregnated with (containing) the aerosol generating substance may be disposed in the storage portion 220. An electrically conductive track of the heater 210 may have a structure wound around the liquid delivery element. As the liquid delivery element is heated by the heater 210, an aerosol may be produced. Here, the liquid delivery element may be a wick such as cotton fiber, ceramic fiber, glass fiber, or porous ceramic.

The cartridge 200 may include an insertion space 230 configured to allow a stick 20 to be inserted therein. For example, the cartridge 200 may include an insertion space defined by an inner wall (not shown) extending in a circumferential direction along a direction in which the stick 20 is inserted. Here, an inside of the inner wall may be open vertically to define the insertion space. The stick 20 may be inserted into the insertion space 230 defined by the inner wall.

The insertion space into which the stick 20 is inserted may have a shape corresponding to a shape of a portion of the stick 20 inserted into the insertion space. For example, when the stick 20 has a cylindrical shape, the insertion space may be formed in a cylindrical shape.

When the stick 20 is inserted into the insertion space, an outer circumferential surface of the stick 20 may be surrounded by the inner wall to be in contact with the inner wall.

A portion of the stick 20 may be inserted into the insertion space 230 of the cartridge 200, and the remaining portion may be exposed to the outside.

The user may inhale an aerosol while holding one end of the stick 20 in his or her mouth. An aerosol generated by the heater 210 may pass through the stick 20 to be delivered to the mouth of the user. Here, a material included in the stick 20 may be added to the aerosol while passing through the stick 20, and the material-added aerosol may be inhaled into the mouth of the user through the one end of the stick 20.

Referring to FIG. 4, the aerosol generating device 10 according to this embodiment may include a body 100 that supports a cartridge 200 and the cartridge 200 that contains an aerosol generating substance. The body 100 may be configured such that a stick 20 is insertable into an insertion space 130.

The aerosol generating device 10 may include a first heater configured to heat the aerosol generating substance stored in the cartridge 200. For example, when a user puff on one end of the stick 20 with his or her mouth, an aerosol generated by the first heater may pass through the stick 20. Here, a flavoring may be added to the aerosol while passing through the stick 20. The flavored aerosol may be inhaled into the mouth of the user through the one end of the stick 20.

In another embodiment, the aerosol generating device 10 may include a first heater configured to heat the aerosol generating substance stored in the cartridge 200 and a second heater configured to heat the stick 20 inserted into the body 100. For example, the aerosol generating device 10 may generate an aerosol by heating the aerosol generating substance stored in the cartridge 200 and the stick 20 through the first heater and the second heater, respectively.

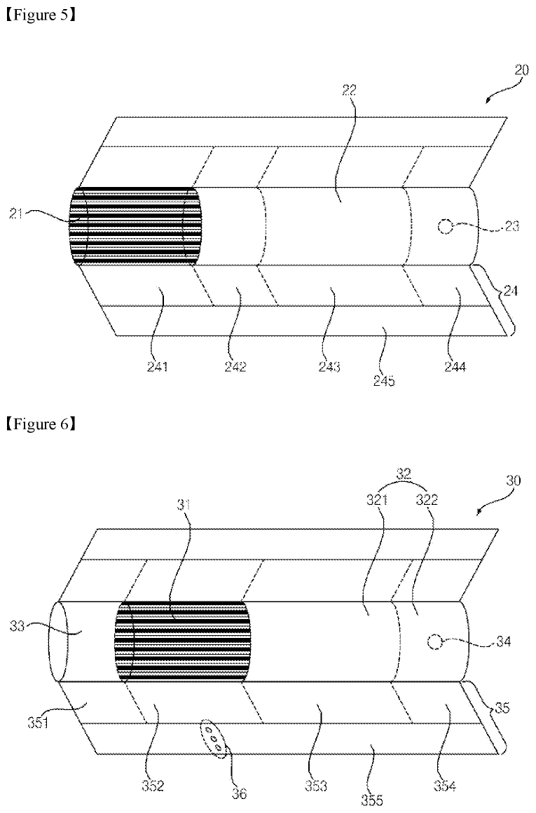

FIGS. 5 to 7 are views for explaining a stick according to embodiments of the present disclosure. Overlapping descriptions in FIGS. 5 to 7 will be omitted.

Referring to FIG. 5, a stick 20 according to this embodiment may include a tobacco rod 21 and a filter rod 22. The first part described above with reference to FIG. 2 may include the tobacco rod 21. The second part described above with reference to FIG. 2 may include the filter rod 22.

The filter rod 22 in FIG. 5 is shown as a single segment but is not limited thereto. In other words, the filter rod 22 may include a plurality of segments. For example, the filter rod 22 may include a first segment for cooling an aerosol and a second segment for filtering a predetermined component included in the aerosol. In addition, when necessary, the filter rod 22 may further include at least one segment performing another function.

A diameter of the stick 20 may be in a range of 5 mm to 9 mm, and a length of the stick 20 may be about 48 mm. However, the present disclosure is not limited thereto. For example, a length of the tobacco rod 21 may be about 12 mm, a length of the first segment of the filter rod 22 may be about 10 mm, a length of the second segment of the filter rod 22 may be about 14 mm, and a length of a third segment of the filter rod 22 may be about 12 mm. However, the present disclosure is not limited thereto.

The stick 20 may be wrapped by at least one wrapper 24. The wrapper 24 may have at least one hole through which external air is introduced or internal gas is discharged. In one example, the stick 20 may be wrapped by one wrapper 24. In another example, the stick 20 may be wrapped by two or more wrappers 24 in an overlapping manner. For example, the tobacco rod 21 may be wrapped by a first wrapper 241. For example, the filter rod 22 may be wrapped by second wrappers 242, 243, and 244. The tobacco rod 21 and the filter rod 22, which are wrapped by the respective wrappers, may be coupled to each other. The entire stick 20 may be rewrapped by a third wrapper 245. When the filter rod 22 consists of a plurality of segments, each of the segments may be wrapped by an individual wrapper (242, 243, 244). In addition, the entire stick 20 in which the segments respectively wrapped by the individual wrappers are coupled to one another may be rewrapped by another wrapper.

The first wrapper 241 and the second wrapper 242 may be made of general filter wrapping paper. For example, the first wrapper 241 and the second wrapper 242 may be porous wrappers or non-porous wrappers. In addition, the first wrapper 241 and the second wrapper 242 may be made of paper and/or an aluminum laminate packaging material with oil resistance.

The third wrapper 243 may be made of hard wrapping paper. For example, a basis weight of the third wrapper 243 may be in a range of 88 g/m² to 96 g/m². For example, a basis weight of the third wrapper 243 may be in a range of 90 g/m² to 94 g/m². In addition, a thickness of the third wrapper 243 may be in a range of 120 μm to 130 μm. For example, the thickness of the third wrapper 243 may be 125 μm.

The fourth wrapper 244 may be made of an oil-resistant hard wrapping paper. For example, a basis weight of the fourth wrapper 244 may be in a range of 88 g/m² to 96 g/m². For example, a basis weight of the fourth wrapper 244 may be in a range of 90 g/m² to 94 g/m². In addition, a thickness of the fourth wrapper 244 may be in a range of 120 μm to 130 μm. For example, the thickness of the fourth wrapper 244 may be 125 μm.

The fifth wrapper 245 may be made of sterile paper (MFW). Here, the sterile paper (MFW) may refer to paper specially designed to have improved tensile strength, water resistance, smoothness, and the like compared to general paper. For example, a basis weight of the fifth wrapper 245 may be in a range of 57 g/m² to 63 g/m². For example, a basis weight of the fifth wrapper 245 may be 60 g/m². In addition, a thickness of the fifth wrapper 245 may be in a range of 64 μm to 70 μm. For example, the thickness of the fifth wrapper 245 may be 67 μm.

A predetermined material may be added into the fifth wrapper 245. Here, an example of the predetermined material may be silicone, but is not limited thereto. For example, silicone may have properties such as heat resistance having little change with temperature, oxidation resistance, resistance to various chemicals, water repellency to water, electrical insulation, etc. However, other than the silicone, any material having the above-described properties may be applied onto or coated on the fifth wrapper 245.

The fifth wrapper 245 may prevent combustion of the stick 20. For example, when the tobacco rod 21 is heated by the heater 110, there may exist a possibility of combustion of the stick 20. In detail, when the temperature rises above the ignition point of any one of the materials included in the tobacco rod 21, the stick 20 may be combustible. However, as the fifth wrapper 245 includes a non-combustible material, the combustion of the stick 20 may be prevented.

In addition, the fifth wrapper 245 may prevent the body 100 from being contaminated by materials generated in the stick 20. Liquid materials may be generated in the stick 20 due to a puff by a user. For example, as an aerosol produced in the stick 20 is cooled by external air, liquids (e.g., moisture, etc.) may be generated. As the stick 20 is wrapped by the fifth wrapper 245, the liquids generated in the stick 20 may be prevented from leaking out of the stick 20.

The tobacco rod 21 may include an aerosol generating substance. For example, the aerosol generating substance may include, but is not limited to, at least one of glycerin, propylene glycol, ethylene glycol, dipropylene glycol, diethylene glycol, triethylene glycol, tetraethylene glycol, and oleyl alcohol. Also, the tobacco rod 21 may contain other additives such as a flavoring agent, a wetting agent, and/or an organic acid. In addition, a flavoring liquid, such as menthol or humectant, may be added to the tobacco rod 21 by being sprayed onto the tobacco rod 21.

The tobacco rod 21 may be manufactured in various ways. For example, the tobacco rod 21 may be made of a sheet. For example, the tobacco rod 21 may be made of strands. For example, the tobacco rod 21 may be made of shredded tobacco obtained by finely cutting a tobacco sheet. For example, the tobacco rod 21 may be surrounded by a heat conductive material. For example, the heat conductive material may be a metal foil such as aluminum foil, but is not limited thereto. For example, the heat conductive material surrounding the tobacco rod 21 may evenly distribute or disperse heat transferred to the tobacco rod 21 to improve thermal conductivity applied to the tobacco rod 21, thereby improving the taste of tobacco. The heat conductive material surrounding the tobacco rod 21 may serve as a susceptor heated by an induction heater. Although not shown in the drawing, the tobacco rod 21 may further include an additional susceptor in addition to the heat conductive material surrounding an outside thereof.

The filter rod 22 may be a cellulose acetate filter. Moreover, the filter rod 22 is not limited to a particular shape. For example, the filter rod 22 may be a cylinder type rod. For example, the filter rod 22 may be a tube type rod including a hollow therein. For example, the filter rod 22 may be a recess type rod. When the filter rod 22 consists of a plurality of segments, at least one of the plurality of segments may have a different shape from the others.

The first segment of the filter rod 22 may be a cellulose acetate filter. For example, the first segment may be a tube-shaped structure including a hollow therein. The first segment may prevent an inner material of the tobacco rod 21 from being pushed back upon insertion of the heater 110, and may provide the effect of cooling an aerosol. A diameter of the hollow included in the first segment may be appropriately determined or selected in a range of 2 mm to 4.5 mm, but is not limited thereto.

A length of the first segment may be appropriately determined in a range of 4 mm to 30 mm, but is not limited thereto. For example, the length of the first segment may be 10 mm, but is not limited thereto.

The second segment of the filter rod 22 cools an aerosol generated when the heater 110 heats the tobacco rod 21. Thus, the user may inhale an aerosol cooled to an appropriate temperature.

A length or diameter of the second segment may be variously determined according to the shape of the stick 20. For example, the length of the second segment may be appropriately selected in a range of 7 mm to 20 mm. More preferably, the length of the second segment may be about 14 mm, but is not limited thereto.

The second segment may be made by weaving polymer fibers. In this case, a flavoring liquid may be applied to a fiber made of polymers. Alternatively, the second segment may be made by weaving a separate fiber coated with a flavoring liquid and a fiber made of polymers together. Alternatively, the second segment may be made of a crimped polymer sheet.

For example, a polymer may be made of a material selected from the group consisting of polyethylene (PE), polypropylene (PP), polyvinyl chloride (PVC), polyethylene terephthalate (PET), polylactic acid (PLA), cellulose acetate (CA), and aluminum foil.

As the second segment is made of the woven polymer fiber or the crimped polymer sheet, the second segment may include a single channel or a plurality of channels extending in a longitudinal direction. Here, the “channel” may refer to a passage through which gas (e.g., air or aerosol) passes.

For example, the second segment made of a crimped polymer sheet may be made from a material having a thickness between 5 μm and 300 μm, namely, between 10 μm and 250 μm. Also, a total surface area of the second segment may be between 300 mm²/mm and 1000 mm²/mm. In addition, an aerosol cooling element may be made from a material with a specific surface area between 10 mm²/mg and 100 mm²/mg.

Meanwhile, the second segment may include a thread containing a volatile flavor component. Here, the volatile flavor component may be menthol, but is not limited thereto. For example, the thread may be filled with a sufficient amount of menthol to provide at least 1.5 mg of menthol to the second segment.

The third segment of the filter rod 22 may be a cellulose acetate filter. A length of the third segment may be appropriately selected in a range of 4 mm to 20 mm. For example, the length of the third segment may be about 12 mm, but is not limited thereto.

The filter rod 22 may be manufactured to generate flavor. In one example, a flavoring liquid may be sprayed onto the filter rod 22. In another example, a separate fiber coated with a flavoring liquid may be inserted into the filter rod 22.

In addition, the filter rod 22 may include at least one capsule 23. Here, the capsule 23 may perform a function of generating flavor. The capsule 23 may also perform a function of generating an aerosol. For example, the capsule 23 may have a structure in which a liquid containing a flavoring material is wrapped with a film. The capsule 23 may have a spherical or cylindrical shape, but is not limited thereto.

Referring to FIG. 6, a stick 30 according to this embodiment may further include a front-end plug 33. The front-end plug 33 is disposed on one side opposite a filter rod 32 with respect to a tobacco rod 31. The front-end plug 33 may prevent the tobacco rod 31 from being separated to the outside. The front-end plug 33 may prevent a liquefied aerosol from flowing into the aerosol generating device 10 from the tobacco rod 31 while smoking.

The filter rod 32 may include a first segment 321 and a second segment 322. The first segment 321 may correspond to the first segment of the filter rod 22 of FIG. 5. The second segment 322 may correspond to the third segment of the filter rod 22 of FIG. 5.

A diameter and an overall length of the stick 30 may correspond to the diameter and the overall length of the stick 20 of FIG. 5. For example, a length of the front-end plug 33 may be about 7 mm, a length of the tobacco rod 31 may be about 15 mm, a length of the first segment 321 may be about 12 mm, and a length of the second segment 322 may be about 14 mm. However, the present disclosure is not limited thereto.

The stick 30 may be wrapped by at least one wrapper 35. The wrapper 35 may have at least one hole through which external air is introduced or internal gas is discharged. For example, the front-end plug 33 may be wrapped by a first wrapper 351, the tobacco rod 31 may be wrapped by a second wrapper 352, the first segment 321 may be wrapped by a third wrapper 353, and the second segment 322 may be wrapped by a fourth wrapper 354. Then, the entire stick 30 may be rewrapped by a fifth wrapper 355.

In addition, the fifth wrapper 355 may have at least one perforation 36. For example, the perforation 36 may be formed in an area surrounding the tobacco rod 31, but is not limited thereto. For example, the perforation 36 may serve to transfer heat generated by the heater 210 of FIG. 3 to an inside of the tobacco rod 31.

Also, the second segment 322 may include at least one capsule 34. Here, the capsule 34 may perform a function of generating flavor. The capsule 34 may also perform a function of generating an aerosol. For example, the capsule 34 may have a structure in which a liquid containing a flavoring material is wrapped with a film. The capsule 34 may have a spherical or cylindrical shape, but is not limited thereto.

The first wrapper 351 may be made by coupling a metal foil, such as aluminum foil, to general filter wrapping paper. For example, a total thickness of the first wrapper 351 may be in a range of 45 μm to 55 μm. For example, the total thickness of the first wrapper 351 may be 50.3 μm. In addition, a thickness of the metal foil of the first wrapper 351 may be in a range of 6 μm to 7 μm. For example, the thickness of the metal foil of the first wrapper 351 may be 6.3 μm. In addition, a basis weight of the first wrapper 351 may be in a range of 50 g/m² to 55 g/m². For example, the basis weight of the first wrapper 351 may be 53 g/m².

The second wrapper 352 and the third wrapper 353 may be made of general filter wrapping paper. For example, the second wrapper 352 and the third wrapper 353 may be porous wrappers or non-porous wrappers.

For example, porosity of the second wrapper 352 may be 35000 CU, but is not limited thereto. In addition, a thickness of the second wrapper 352 may be in a range of 70 μm to 80 μm. For example, the thickness of the second wrapper 352 may be 78 μm. In addition, a basis weight of the second wrapper 352 may be in a range of 20 g/m² to 25 g/m². For example, the basis weight of the second wrapper 352 may be 23.5 g/m².

For example, porosity of the third wrapper 353 may be 24000 CU, but is not limited thereto. In addition, a thickness of the third wrapper 353 may be in a range of 60 μm to 70 μm. For example, the thickness of the third wrapper 353 may be 68 μm. In addition, a basis weight of the third wrapper 353 may be in a range of 20 g/m² to 25 g/m². For example, the basis weight of the third wrapper 353 may be 21 g/m².

The fourth wrapper 354 may be made of PLA laminated paper. Here, the PLA laminated paper may refer to a three-layer paper consisting of a paper layer, a PLA layer, and a paper layer. For example, a thickness of the fourth wrapper 354 may be in a range of 100 μm to 120 μm. For example, the thickness of the fourth wrapper 354 may be 110 μm. In addition, a basis weight of the fourth wrapper 354 may be in a range of 80 g/m² to 100 g/m². For example, the basis weight of the fourth wrapper 354 may be 88 g/m².

The fifth wrapper 355 may be made of sterile paper (MFW). Here, the sterile paper (MFW) may refer to paper specially designed to have improved tensile strength, water resistance, smoothness, and the like compared to general paper. For example, a basis weight of the fifth wrapper 355 may be in a range of 57 g/m² to 63 g/m². For example, the basis weight of the fifth wrapper 355 may be 60 g/m². In addition, a thickness of the fifth wrapper 355 may be in a range of 64 μm to 70 μm. For example, the thickness of the fifth wrapper 355 may be 67 μm.

A predetermined material may be added into the fifth wrapper 355. Here, an example of the predetermined material may be silicone, but is not limited thereto. For example, silicone has properties such as heat resistance with little change with temperature, oxidation resistance, resistance to various chemicals, water repellency to water, electrical insulation, etc. However, other than the silicone, any material having the above-described properties may be applied (or coated) onto the fifth wrapper 355.

The front-end plug 33 may be made of cellulose acetate. In one example, the front-end plug 33 may be made by adding a plasticizer (e.g., triacetin) to cellulose acetate tow. A mono denier of a filament constituting the cellulose acetate tow may be in a range of 1.0 to 10.0. For example, the mono denier of the filament constituting the cellulose acetate tow may be in a range of 4.0 to 6.0. For example, a mono denier of a filament of the front-end plug 33 may be 5.0. In addition, a cross section of the filament of the front-end plug 33 may be a Y-shape. A total denier of the front-end plug 33 may be in a range of 20000 to 30000. For example, the total denier of the front-end plug 33 may be in a range of 25000 to 30000. For example, the total denier of the front-end plug 33 may be 28000.

In addition, when necessary, the front-end plug 33 may include at least one channel. A shape of a cross section of the channel of the front-end plug 330 may be formed in various ways.

The tobacco rod 31 may correspond to the tobacco rod 21 described above with reference to FIG. 5. Therefore, a detailed description of the tobacco rod 31 will be omitted.

The first segment 321 may be made of cellulose acetate. For example, the first segment may be a tube-shaped structure including a hollow therein. The first segment 321 may be made by adding a plasticizer (e.g., triacetin) to cellulose acetate tow. For example, a mono denier and a total denier of the first segment 321 may be the same as the mono denier and the total denier of the front-end plug 33.

The second segment 322 may be made of cellulose acetate. A mono denier of a filament of the second segment 322 may be in a range of 1.0 to 10.0. For example, the mono denier of the filament of the second segment 322 may be in a range of 8.0 to 10.0. For example, the mono denier of the filament of the second segment 322 may be 9.0. In addition, a cross section of the filament of the second segment 322 may be a Y-shape. A total denier of the second segment 322 may be in a range of 20000 to 30000. For example, the total denier of the second segment 322 may be 25000.

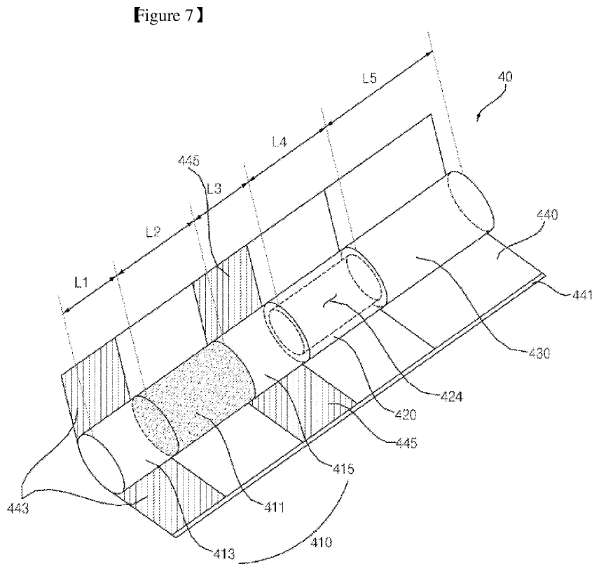

Referring to FIG. 7, a stick 40 may include a medium portion 410. The stick 400 may include a cooling portion 420. The stick 40 may include a filter portion 430. The cooling portion 420 may be disposed between the medium portion 410 and the filter portion 430. The stick 400 may include a wrapper 440. The wrapper 440 may wrap the medium portion 410. The wrapper 440 may wrap the cooling portion 420. The wrapper 440 may wrap the filter portion 430. The stick 400 may have a cylindrical shape.

The medium portion 410 may include a medium 411. The medium portion 410 may include a first medium cover 413. The medium portion 410 may include a second medium cover 415. The medium 411 may be disposed between the first medium cover 413 and the second medium cover 415. The first medium cover 413 may be disposed at one end of the stick 400. The medium portion 410 may have a length of 24 mm.

The medium 411 may contain a multicomponent substance. The substance contained in the medium may be a multicomponent flavoring substance. The medium 411 may be composed of a plurality of granules. Each of the plurality of granules may have a size of 0.4 mm to 1.12 mm. The granules may account for approximately 70% of the volume of the medium 411. A length L2 of the medium 411 may be 10 mm. The first medium cover 413 may be made of an acetate material. The second medium cover 415 may be made of an acetate material. The first medium cover 413 may be made of a paper material. The second medium cover 415 may be made of a paper material. At least one of the first medium cover 413 and the second medium cover 415 may be made of a paper material to be crumpled with wrinkles, and a plurality of gaps may be formed between the wrinkles to allow air to flow therethrough. Each of the gaps may be smaller than each of the granules of the medium 411. A length L1 of the first medium cover 413 may be less than the length L2 of the medium 411. A length L3 of the second medium cover 415 may be less than the length L2 of the medium 411. The length L1 of the first medium cover 413 may be 7 mm. The length L2 of the second medium cover 415 may be 7 mm.

Accordingly, each of the granules of the medium 411 may be prevented from being separated from the medium portion 410 and the stick 40.

The cooling portion 420 may have a cylindrical shape. The cooling portion 420 may have a hollow shape. The cooling portion 420 may be disposed between the medium portion 410 and the filter portion 430. The cooling portion 420 may be disposed between the second medium cover 415 and the filter portion 430. The cooling portion 420 may be formed in the shape of a tube that surrounds a cooling path 424 formed therein. The cooling portion 420 may be thicker than the wrapper 440. The cooling portion 420 may be made of a paper material thicker than that of the wrapper 440. A length L4 of the cooling portion 420 may be equal or similar to the length L2 of the medium 411. The length L4, which is the length of the cooling portion 420 and the cooling path 424, may be 10 mm. When the stick 400 is inserted into the aerosol generating device 10, at least a portion of the cooling portion 420 may be exposed to an outside of the aerosol generating device 10.

Accordingly, the cooling portion 420 may support the medium portion 410 and the filter portion 430, and may achieve the rigidity of the stick 400. In addition, the cooling portion 420 may support the wrapper 440 between the medium portion 410 and the filter portion 430, and may provide a portion to which the wrapper 440 is adhered. In addition, heated air and aerosol may be cooled while passing through the cooling path 424 in the cooling portion 420.

The filter portion 430 may be configured as a filter made of an acetate material. The filter portion 430 may be disposed at another end of the stick 400. When the stick 400 is inserted into the aerosol generating device 10, the filter portion 430 may be exposed to the outside of the aerosol generating device 10. A user may inhale air while holding the filter portion 430 in his or her mouth. A length L5 of the filter portion 430 may be 14 mm.

The wrapper 440 may wrap or surround the medium portion 410, the cooling portion 420, and the filter portion 430. The wrapper 440 may define an outer appearance of the stick 400. The wrapper 440 may be made of a paper material. An adhesive portion 441 may be formed along one edge of the wrapper 440. The wrapper 440 may surround the medium portion 410, the cooling portion 420 and the filter portion 430, and the adhesive portion 441 formed along the one edge of the wrapper 440 and another edge of the wrapper 440 may be adhered to each other. The wrapper 440 may surround the medium portion 410, the cooling portion 420, and the filter portion 430, but may not cover one end and another end of the stick 400.

Accordingly, the wrapper 440 may fix the medium portion 410, the cooling portion 420, and the filter portion 430, and may prevent these components from being separated from the stick 400.

A first thin film 443 may be disposed at a position corresponding to the first medium cover 413. The first thin film 443 may be disposed between the wrapper 440 and the first medium cover 413, or may be disposed outside the wrapper 440. The first thin film 443 may surround the first medium cover 413. The first thin film 443 may be made of a metal material. The first thin film 443 may be made of an aluminum material. The first thin film 443 may be in close contact with or coated on the wrapper 440.

A second thin film 445 may be disposed at a position corresponding to the second medium cover 415. The second thin film 445 may be disposed between the wrapper 440 and the second medium cover 415, or may be disposed outside the wrapper 440. The second thin film 445 may be made of a metal material. The second thin film 445 may be made of an aluminum material. The second thin film 445 may be in close contact with or coated on the wrapper 440.

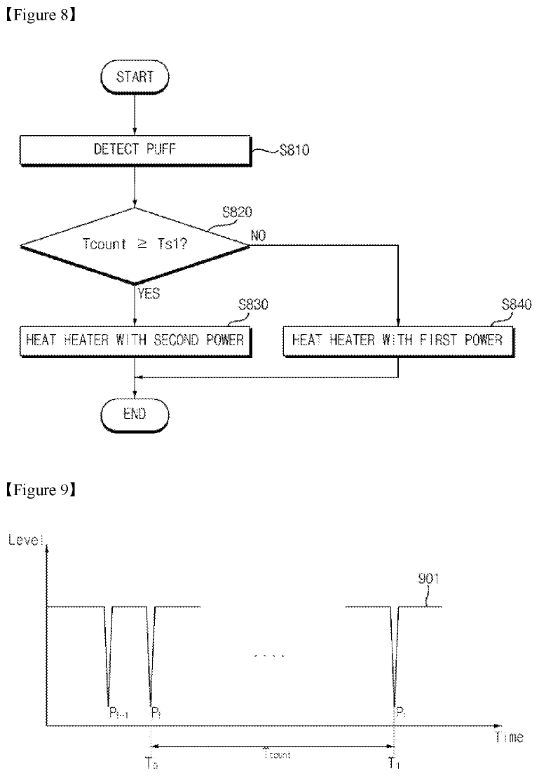

FIG. 8 is a flowchart illustrating the operation of an aerosol generating device according to an embodiment of the present disclosure, and FIGS. 9 to 11 are views referenced to describe examples of the operation of the aerosol generating device of FIG. 8.

Referring to FIGS. 8 and 9, the aerosol generating device 10 may detect a puff in operation S810. The first sensor of the aerosol generating device 10 may detect a first puff and a second puff. The first sensor may be the puff sensor 151. The aerosol generating device 10 may detect the first puff and the second puff based on a signal 901 output by the puff sensor 151.

A second puff p_{f+1} may be a puff occurring after a first puff pr. For example, a puff (another puff) occurring between the first puff p_{f} and the second puff p_{f+1}, which are detected by the puff sensor 151, may not be detected. For example, the second puff pr. 1 may be detected within a few seconds after the occurrence of the first puff p_{f}, or may be detected several tens of hours later. For example, the second puff p_{f+1} may be a puff inhaled by a user that occurs after non-use of the cartridge 200 for a long time from the first puff pr.

In operation S820, based on detecting, through the puff sensor 151, the first puff and the second puff occurring after the first puff, the aerosol generating device 10 may count an elapsed time T_{count} between the first puff and the second puff to compare the counted elapsed time T_{count} with a first time threshold. The first time threshold may be a first set time T_{S1}.

The aerosol generating device 10 may start counting a time from a time point T₀ at which the first puff is detected and stop counting at a time point T₁ at which the second puff is detected, and may determine a counted value as an elapsed time T_{count}. Whenever a puff is detected, the aerosol generating device 10 may start counting a time from a time point at which a corresponding puff is detected and stop counting at a time point at which another or subsequent puff is detected. The first set time T_{S1} may be prestored in the memory 14 of the aerosol generating device 10. The aerosol generating device 10 may compare the elapsed time T_{count} with the first set time T_{S1} stored in the memory 14 to determine whether the elapsed time T_{count} is greater than or equal to the first set time T_{S1}.

When the elapsed time T_{count} is determined to be greater than or equal to the first set time T_{S1}, the aerosol generating device 10 may supply second power P₂ to the heater 131, so that heat is applied to the heater 131 in operation S830. The battery 16 of the aerosol generating device 10 may supply the second power P₂ to the heater 131. The second power P₂ may be higher than first power P₁.

When the first power P₁ is supplied to the heater 131 for a predetermined time, the heater 131 may be heated at a temperature greater than or equal to the vaporization temperature of an aerosol generating substance. The aerosol generating substance may be heated by the heated heater 131, causing the aerosol generating substance to vaporize. When the second power P₂ is supplied to the heater 131 for a predetermined time, the heater 131 may be heated at a temperature greater than or equal to the vaporization temperature of the aerosol generating substance. When the second power P₂ is supplied to the heater 131 for the predetermined time, the heater 131 may be heated at a higher temperature than when the first power P₁ is supplied to the heater 131 for the predetermined time.

The aerosol generating device 10 may include a container 220 that holds or accommodate an aerosol generating substance. The container 220 may be provided in the cartridge 200. The aerosol generating substance accommodated in the container 220 may be disposed inside the container 220 or disposed adjacent to the container 220 to be impregnated into a liquid delivery element in communication with an inside of the container 220. The heater 131 may have a structure wound around the liquid delivery element.

When the cartridge 200 is not used for a long time, the liquid delivery element may be impregnated with a large amount of aerosol generating substance leaked from the container 220 of the cartridge 200.

As the heater 131 is supplied with the second power P₂ higher than the first power P₁, the heater 131 may heat the liquid delivery element at a high temperature, thereby efficiently vaporizing the aerosol generating substance impregnated in the liquid delivery element of the cartridge 200 that is left unused for a long time.

The supply of the first power P₁ or the second power P₂ to the heater 131 may mean that first power P₁ or second power P₂ having a predetermined magnitude for each puff is supplied to the heater 131 in a constant manner. Alternatively, the supply of the first power P₁ or the second power P₂ to the heater 131 may mean that, whenever a puff occurs, first power P₁ or second power P₂ is supplied to the heater 131 for a predetermined time (e.g., 2 seconds) from a time point of the occurrence of a corresponding puff, and after the predetermined time has elapsed, power lower than the first power P₁ or power lower than the second power P₂ is supplied to the heater 131. However, the method of supplying the first power P₁ or the second power P₂ to the heater 131 is not limited thereto.

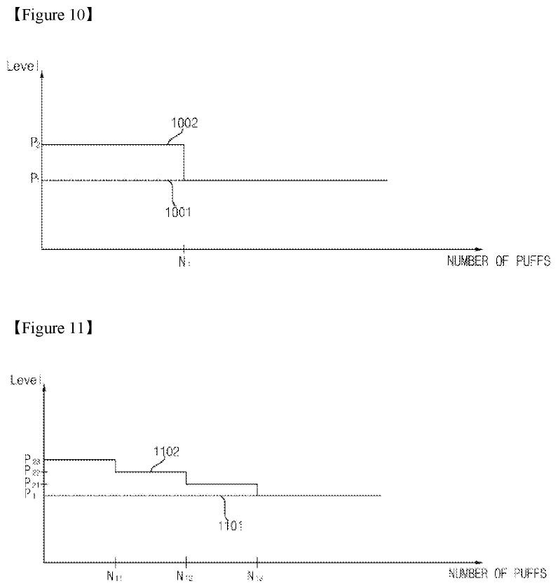

Referring to FIG. 10, when the elapsed time T_{count} is determined to be greater than or equal to the first set time T_{S1}, the aerosol generating device 10 may supply the second power P₂ to the heater 131 only for a puff corresponding to a set number (first set number) (see 1002 of FIG. 10).

The aerosol generating device 10 may detect, through the puff sensor 151, a puff(s) corresponding to a first set number N₁ occurring after the second puff. Based on the elapsed time T_{count} being greater than or equal to the first set time T_{S1}, the aerosol generating device 10 may control such that the second power is P₂ supplied to the heater 131 for the puff(s) corresponding to the first set number N₁ starting from the second puff. The aerosol generating device 10 may control such that the second power P₂, is supplied to the heater 131 during from the second puff to an N₁-1th puff occurring after the second puff.

The aerosol generating device 10 may control such that the first power P₁ is supplied to the heater 131 in response to at least one puff occurring after the puff(s) corresponding to the first set number N₁.

Referring back to FIG. 8, when the elapsed time T_{count} is determined to be less than the first set time T_{S1}, the aerosol generating device 10 may heat the heater 131 with the first power P₁ (see 1001 of FIG. 10) in operation S840. The battery 16 of the aerosol generating device 10 may supply the first power P₁ to the heater 131. The first power P₁ may be lower than the second power P₂.

The first set time T_{S1} may be a time during which the cartridge 200 is left unused. For example, the first set time T_{S1} may be 72 hours. The first set time T_{S1} may be set or determined based on experimental data, etc. However, the first set time T_{S1} is not limited thereto.

The second power P₂ may be set to be greater than the first power P₁ by a predetermined ratio or more.

TABLE 1

| Aerosol generating device | First power (W) | Second power (W) |
|---|---|---|
| First device | 9 W | 10~12 W |
| Second device | 7.5 W | 10~12 W |

Referring to Table 1, in a general heating mode (normal mode), first power P₁ may be power supplied to the heater 131 for heating the heater 131. For example, in the case of a first device, first power P₁ may be set to about 9 watts (W). For example, in the case of a second device, first power P₁ may be set to about 7.5 watts (W). However, the magnitude of the first power P₁ is not limited thereto, and its value may vary depending on the type of an aerosol generating device used, the type of an aerosol generating substance, etc. In a leaking liquid heating mode (boost mode), second power P₂ may be supplied to the heater 131 for heating the heater 131. For example, in the case of the first device, second power P₂ may be set to about 10 to 12 watts (W). As for the first device, the magnitude of the second power P₂ may be about 110% to 130% of the magnitude of the first power P₁. For example, in the case of the second device, second power P₂ may be set to about 12 watts (W). As for the second device, the magnitude of the second power P₂ may be about 130% to 160% of the magnitude of the first power P₁. However, the magnitude of the second power P₂ is not limited thereto, and its value may vary depending on the type of an aerosol generating device used, the type of an aerosol generating substance, etc.

Meanwhile, the first set number N₁ may refer to the number of puffs from the second puff to a puff reaching the average aerosol atomization amount while the first power P₁ is supplied to the heater 131. For example, the first set number N₁ may be five (5). The first set number N₁ may be set based on experimental data, etc. However, the first set number N₁ is not limited thereto.

Referring to FIG. 11, when the elapsed time T_{count} is determined to be greater than or equal to the first set time T_{S1}, the aerosol generating device 10 may supply power higher than first power P₁ to the heater 131 for a puff corresponding to a set number (first set number). The aerosol generating device 10 may control such that power supplied to the heater 131 is gradually (or incrementally) reduced from second power P₂₃ to the first power P₁ (see 1102 in FIG. 11) for a puff corresponding to a first set number N₁₃ starting from the second puff.

For example, the aerosol generating device 10 may divide the puffs from the second puff to the puff corresponding to the first set number N₁₃ into three puff sections. The aerosol generating device 10 may supply the second power P₂₃ to the heater 131 during from the second puff to an N₁₁-1th puff, which belong to a first section, may supply fourth power P₂₂ lower than the second power P₂₃ to the heater 131 during from an Nuth puff to an N₁₂-1th puff, which belong to a second section, and may supply fifth power P₂₁ lower than the fourth power P₂₂ to the heater 131 during from an N₁₂th puff to an N₁₃-1th puff, which belong to a third section. Here, the fourth power P₂₂ and the fifth power P₂₁ may be higher than the first power P₁.

The aerosol generating device 10 may control such that the first power P₁ is supplied to the heater 131 in response to at least one puff occurring after the puff(s) corresponding to the first set number N₁₃. Although the puffs from the second puff to the puff corresponding to the first set number N₁₃ are divided into the three puff sections in FIG. 11, the number of puff sections is not limited thereto, which may be two sections or greater than or equal to four sections.

After the occurrence of the puff corresponding to the first set number N₁₃, when the power supplied to the heater 131 is decreased from the second power P₂₃ to the first power P₁, a drastic change in amount of atomization generated by a puff may occur. As the aerosol generating device 10 controls the power, supplied to the heater 131 for the puff corresponding to the first set number N₁₃ starting from the second puff, to be gradually (or incrementally) reduced from the second power P₂₃ to the first power P₁, the sense of difference or discomfort that the user may feel due to the change in amount of atomization may be minimized.

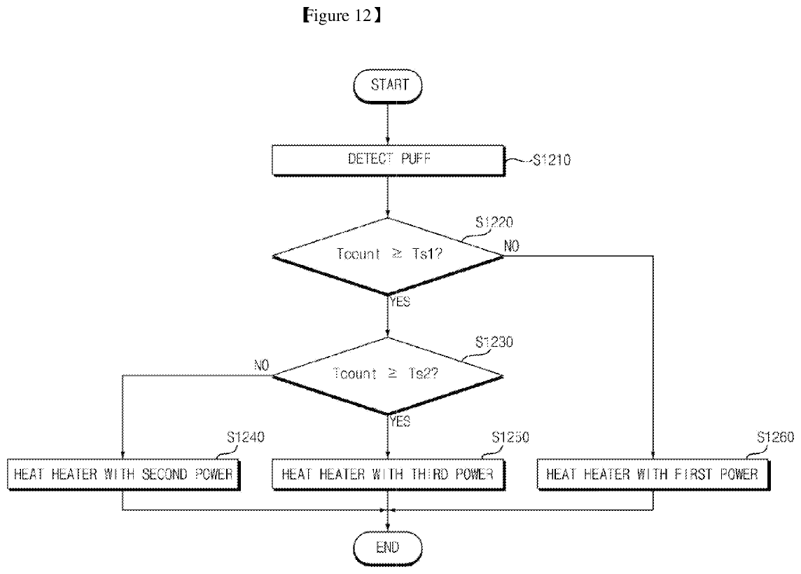

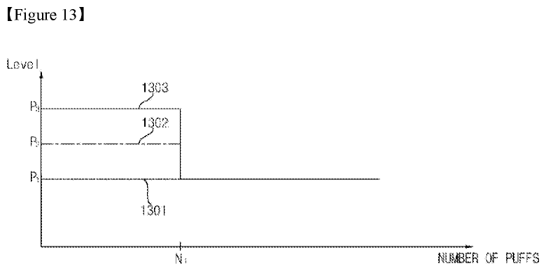

FIG. 12 is a flowchart illustrating the operation of an aerosol generating device according to another embodiment of the present disclosure, and FIG. 13 is a view referenced to describe an example of the operation of the aerosol generating device of FIG. 12. In FIG. 12, a detailed description overlapping the description of FIG. 8 will be omitted.

Referring to FIGS. 12 and 13, the aerosol generating device 10 may detect a puff in operation S1210. The puff sensor 151 of the aerosol generating device 10 may detect a first puff and a second puff. The aerosol generating device 10 may detect the first puff and the second puff based on a signal output by the puff sensor 151.

In operation S1220, based on detecting, through the puff sensor 151, the first puff and the second puff occurring after the first puff, the aerosol generating device 10 may count an elapsed time T_{count} to compare the counted elapsed time T_{count} with a first set time T_{S1}. When the elapsed time T_{count} is determined to be greater than or equal to the first set time T_{S1}, the aerosol generating device 10 may compare the elapsed time T_{count} with a second set time T_{S2} in operation S1230. Here, the second set time T_{S2} may be longer than the first set time T_{S1}.

The first set time T_{S1} and the second set time T_{S2} may be prestored in the memory 14 of the aerosol generating device 10. The aerosol generating device 10 may compare the elapsed time T_{count} with the first set time T_{S1} and the second set time T_{S2} stored in the memory 14, and may determine whether the elapsed time T_{count} is greater than or equal to the first set time T_{S1} and whether the elapsed time T_{count} is greater than or equal to the second set time T_{S2}.

When the elapsed time T_{count} is determined to be greater than or equal to the second set time T_{S2}, the aerosol generating device 10 may supply third power P₃ to the heater 131, so that heat is applied to the heater 131 in operation S1250. The battery 16 of the aerosol generating device 10 may supply the third power P₃ to the heater 131. The third power P₃ may be higher than second power P₂ and first power P₁.

When the elapsed time T_{count} is determined to be less than the second set time T_{S2} and greater than or equal to the first set time T_{S1}, the aerosol generating device 10 may supply the second power P₂ to the heater 131, so that heat is applied to the heater 131 in operation S1240. The battery 16 of the aerosol generating device 10 may supply the second power P₂ to the heater 131. The second power P₂ may be lower than the third power P₃ and higher than the first power P₁.

Referring to FIG. 13, when the elapsed time T_{count} is determined to be greater than or equal to the second set time T_{S2}, the aerosol generating device 10 may supply the third power P₃ to the heater 131 only for a puff corresponding to a set number (first set number) (see 1303 in FIG. 13). When the elapsed time T_{count} is determined to be less than the second set time T_{S2} and greater than or equal to the first set time T_{S1}, the aerosol generating device 10 may supply the second power P₂ to the heater 131 only for a puff corresponding to a set number (the first set number) (see 1302 in FIG. 13).

The aerosol generating device 10 may detect, through the puff sensor 151, a puff(s) corresponding to a first set number N₁ occurring after the second puff. Based on the elapsed time T_{count} being greater than or equal to the second set time T_{S2}, the aerosol generating device 10 may control such that the third power P₃ is supplied to the heater 131 for the puff(s) corresponding to the first set number N₁ starting from the second puff. The aerosol generating device 10 may control such that the third power P₃ is supplied to the heater 131 during from the second puff to an N₁-1th puff occurring after the second puff.

Based on the elapsed time T_{count} being less than the second set time T_{S2} and greater than or equal to the first set time T_{S1}, the aerosol generating device 10 may control such that the second power P₂ is supplied to the heater 131 for a puff(s) corresponding to the first set number N₁ from the second puff. The aerosol generating device 10 may control such that the second power P₂ is supplied to the heater 131 during from the second puff to an N₁-1th puff occurring after the second puff.

The aerosol generating device 10 may control such that the first power P₁ is supplied to the heater 131 in response to at least one puff occurring after the puff(s) corresponding to the first set number N₁.

Referring back to FIG. 12, when the elapsed time T_{count} is determined to be less than the first set time T_{S1}, the aerosol generating device 10 may heat the heater 131 with the first power P₁ in operation S1260. The battery 16 of the aerosol generating device 10 may supply the first power P₁ to the heater 131. The first power P₁ may be lower than the second power P₂ and the third power P₃ (see 1301 of FIG. 13).

The first set time T_{S1} may be a time during which the cartridge 200 is left unused. For example, the first set time T_{S1} may be 72 hours. The second set time T_{S2} may be longer than the first set time T_{S1}. For example, the second set time T_{S2} may be 120 hours. The first set time T_{S1} and the second set time T_{S2} may be set based on experimental data, etc. However, the first set time T_{S1} and the second set time T_{S2} are not limited thereto.

The aerosol generating device 10 may control such that the amount of power supplied to the heater 131 is proportional to a time during which the cartridge 200 is left unused, thereby effectively suppressing a reduction in amount of aerosol generated.

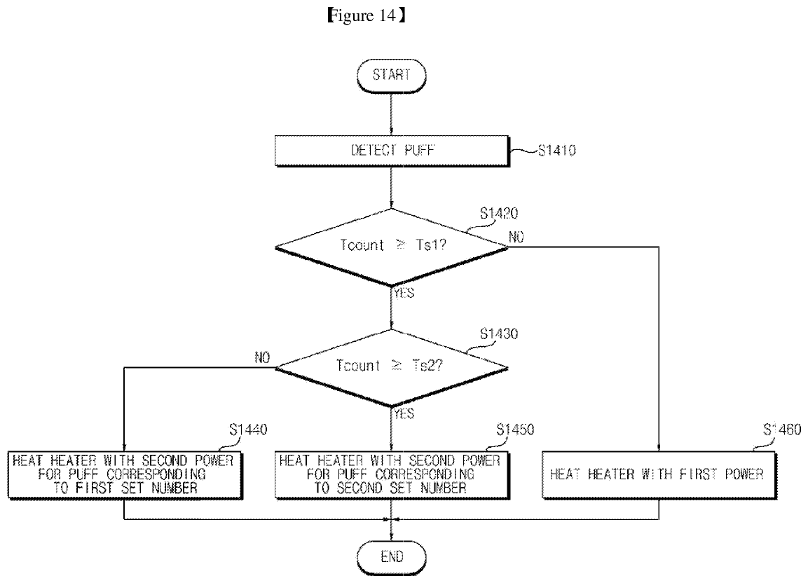

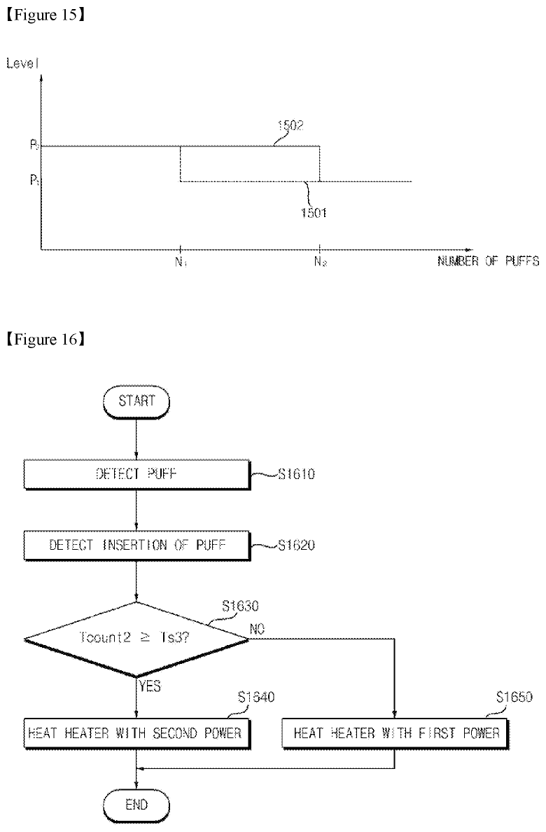

FIG. 14 is a flowchart illustrating the operation of an aerosol generating device according to another embodiment of the present disclosure, and FIG. 15 is a view referenced to describe an example of the operation of the aerosol generating device of FIG. 14. In FIG. 14, a detailed description overlapping the descriptions of FIGS. 8 and 12 will be omitted.

Referring to FIGS. 14 and 15, the aerosol generating device 10 may detect a puff in operation S1410. The puff sensor 151 of the aerosol generating device 10 may detect a first puff and a second puff.

In operation S1420, based on detecting, through the puff sensor 151, the first puff and the second puff occurring after the first puff, the aerosol generating device 10 may count an elapsed time T_{count} to compare the counted elapsed time T_{count} with a first set time T_{S1}.

When the elapsed time T_{count} is determined to be greater than or equal to the first set time T_{S1}, the aerosol generating device 10 may compare the elapsed time T_{count} with a second set time T_{S2} in operation S1430. Here, the second set time T_{S2} may be longer than the first set time T_{S1}.

When the elapsed time T_{count} is determined to be greater than or equal to the second set time T_{S2}, the aerosol generating device 10 may supply second power P₂ to the heater 131, so that heat is applied to the heater 131 in operation S1450. The second power P₂ may be higher than first power P₁.

The aerosol generating device 10 may supply the second power P₂ to the heater 131 only for a puff corresponding to a second set number N₂ (see 1502 of FIG. 15). The second set number N₂ may be greater than the first set number N₁.

The aerosol generating device 10 may detect, through the puff sensor 151, a puff(s) corresponding to the second set number N₂ occurring after the second puff. Based on the elapsed time T_{count} being greater than or equal to the second set time T_{S2}, the aerosol generating device 10 may control such that the second power P₂ is supplied to the heater 131 for the puff(s) corresponding to the second set number N₂ starting from the second puff. The aerosol generating device 10 may control such that the second power P₂ is supplied to the heater 131 during from the second puff to an N₂-1th puff occurring after the second puff.

The aerosol generating device 10 may control such that the first power P₁ is supplied to the heater 131 in response to at least one puff occurring after the puff(s) corresponding to the second set number N₂.

When the elapsed time T_{count} is determined to be less than the second set time T_{S2} and greater than or equal to the first set time T_{S1}, the aerosol generating device 10 may supply the second power P₂ to the heater 131, so that heat is applied to the heater 131 in operation S1440.

The aerosol generating device 10 may supply the second power P₂ to the heater 131 only for a puff corresponding to a first set number N₁ (see 1501 of FIG. 15). The first set number N₁ may be less than the second set number N₂.

The aerosol generating device 10 may detect, through the puff sensor 151, a puff(s) corresponding to the first set number N₁ occurring after the second puff. Based on the elapsed time T_{count} being less than the second set time T_{S2} and greater than or equal to the first set time T_{S1}, the aerosol generating device 10 may control such that the second power P₂ is supplied to the heater 131 for the puff(s) corresponding to the first set number N₁ starting from the second puff. The aerosol generating device 10 may control such that the second power P₂ is supplied to the heater 131 during from the second puff to an N₁-1th puff occurring after the second puff.

The aerosol generating device 10 may control such that the first power P₁ is supplied to the heater 131 in response to at least one puff occurring after the puff(s) corresponding to the first set number N₁.

Referring back to FIG. 14, when the elapsed time T_{count} is determined to be less than the first set time T_{S1}, the aerosol generating device 10 may heat the heater 131 with the first power P₁ in operation S1460. The battery 16 of the aerosol generating device 10 may supply the first power P₁ to the heater 131.

The first set number N₁ and/or the second set number N₂ may refer to the number of puffs from the second puff to a puff reaching the average aerosol atomization amount while the first power P₁ is supplied to the first heater 131. For example, the first set number N₁ may be five (5). For example, the second set number N₂ may be ten (10). The first set number N₁ and the second set number N₂ may be set based on experimental data, etc. However, the first set number N₁ and the second set number N₂ are not limited thereto.

The aerosol generating device 10 may control such that the amount of power supplied to the heater 131 is proportional to a time during which the cartridge 200 is left unused, thereby effectively suppressing a reduction in amount of aerosol generated.

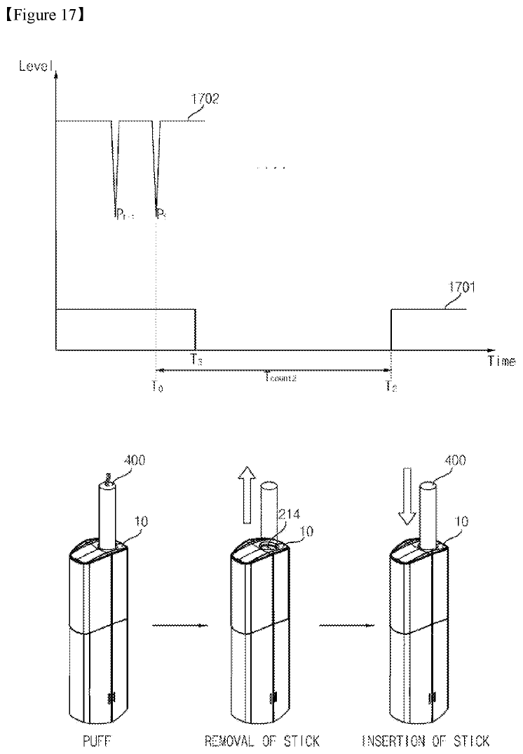

FIG. 16 is a flowchart illustrating the operation of an aerosol generating device according to another embodiment of the present disclosure, and FIG. 17 is a view referenced to describe an example of the operation of the aerosol generating device of FIG. 16.

Referring to FIGS. 16 and 17, the aerosol generating device 10 may detect a puff in operation S1610. The aerosol generating device 10 may detect a third puff p_{f} based on a signal 1702 output by the puff sensor 151.

The aerosol generating device 10 may detect insertion of a stick 400 in operation S1620. The aerosol generating device 10 may include an insertion portion 214 having an elongated space and a stick detection sensor 152 that outputs a signal corresponding to the stick 400 inserted into the insertion portion 214. The aerosol generating device 10 may detect the insertion of the stick 400 based on a signal 1701 output by the stick detection sensor 152.

The insertion of the stick 400 may be detected after the occurrence of the third puff pr. For example, a puff (another puff) occurring between the third puff p_{f} detected by the puff sensor 151 and the insertion of the stick 400 may not be detected. For example, the insertion of the stick 400 may be detected within a few seconds after the occurrence of the third puff p_{f}, or may be detected several tens of hours later. For example, the insertion of the stick 400 may be detected after non-use of the cartridge 200 for a long time from the third puff pr.

In operation S1630, based on detecting the third puff through the puff sensor 151 and based on detecting the insertion of the stick 400 through the stick detection sensor 152, the aerosol generating device 10 may count a second elapsed time T_{count2} from a time point T₀ at which the third puff is detected to a time point T₂ at which the insertion of the stick 400 is detected to compare the counted second elapsed time T_{count2} with a third set time T_{S3}.

The aerosol generating device 10 may start counting a time from the time point T₀ of detecting the third puff and stop counting at the time point T₂ of detecting the insertion of the stick 400, and may determine a counted value as the elapsed time T_{count2}. Whenever a puff is detected, the aerosol generating device 10 may calculate a second elapsed time by starting a count from a time point at which a corresponding puff is detected and stop the count at a time point at which insertion of the stick 400 is detected. In a state in which a count is started at a time point of detecting a puff, when another puff is detected before detecting insertion of the stick 400, the aerosol generating device 10 may not determine a counted value as the second elapsed time T_{count2}.

The third set time T_{S3} may be prestored in the memory 14 of the aerosol generating device 10. The aerosol generating device 10 may compare the second elapsed time T_{count2} with the third set time T_{S3} stored in the memory 14 to determine whether the second elapsed time T_{count2} is greater than or equal to the third set time T_{S3}.

When the second elapsed time T_{count2} is determined to be greater than or equal to the third set time TS₃, the aerosol generating device 10 may supply second power P₂ to the heater 131, so that heat is applied to the heater 131 in operation S1640. The second power P₂ may be higher than first power P₁.

As the second power P₂ higher than the first power P₁ is supplied to the heater 131, the heater 131 may heat a liquid delivery element at a high temperature to thereby effectively vaporize an aerosol generating substance impregnated in the liquid delivery element of the cartridge 200 that is left unused for a long time.

When the second elapsed time T_{count2} is determined to be greater than or equal to the third set time T_{S3}, the aerosol generating device 10 may supply the second power P₂ to the heater 131 only for a puff corresponding to a first set number N₁. The aerosol generating device 10 may control such that the second power P₂ is supplied to the heater 131 during from the third puff to an N₁-1th puff occurring after the third puff.

The aerosol generating device 10 may control such that the first power P₁ is supplied to the heater 131 in response to at least one puff occurring after the puff(s) corresponding to the first set number N₁.

When the second elapsed time T_{count2} is determined to be less than the third set time T_{S3}, the aerosol generating device 10 may heat the heater 131 with the first power P₁ in operation S1650. The battery 16 of the aerosol generating device 10 may supply the first power P₁ to the heater 131.

The aerosol generating device 10 may control such that the amount of power supplied to the heater 131 for preheating and heating of the heater 131 is proportional to a time during which the cartridge 200 is left unused, thereby effectively suppressing a reduction in amount of aerosol generated.

Meanwhile, although not shown in the drawing, the aerosol generating device 10 may detect removal of the stick 400 in operation S1610. The aerosol generating device 10 may detect the removal of the stick 400 based on the signal 1701 output by the stick detection sensor 152.

In operation S1630, based on detecting the removal/insertion of the stick 400 through the stick detection sensor 152, the aerosol generating device 10 may count a third elapsed time T_{count3} from a time point T₃ at which the removal of the stick 400 is detected to a time point T₂ at which the insertion of the stick 400 is detected to compare the counted third elapsed time T_{count3} with the third set time T_{S3}.

The aerosol generating device 10 may start counting a time from the time point T₃ of detecting the removal of the stick 400 and stop counting at the time point T₂ of detecting the insertion of the stick 400, and may determine a counted value as the third elapsed time T_{count3}. Whenever removal of the stick 400 is detected, the aerosol generating device 10 may calculate the third elapsed time T_{count3} by starting a count from a time point of detecting corresponding removal of the stick 400 and stop the count at a time point of detecting insertion of the stick 400 to calculate the third elapsed time T_{count3}.

When the third elapsed time T_{count3} is determined to be greater than or equal to the third set time T_{S3}, the aerosol generating device 10 may supply the second power P₂ to the heater 131, so that heat is applied to the heater 131 in operation S1640. The second power P₂ may be higher than the first power P₁.

As the heater 131 is supplied with the second power P₂ higher than the first power P₁, the heater 131 may heat the liquid delivery element at a high temperature, thereby effectively vaporizing an aerosol generating substance impregnated in the liquid delivery element of the cartridge 200 that is left unused for a long time.

When the third elapsed time T_{count3} is determined to be greater than or equal to the third set time T_{S3}, the aerosol generating device 10 may supply the second power P₂ to the heater 131 only for a puff corresponding to the first set number N₁. The aerosol generating device 10 may control such that the second power P₂ is supplied to the heater 131 up to a puff of a number N₁ occurring after the time point T₂ at which the insertion of the stick 400 is detected.

The aerosol generating device 10 may control such that the first power P₁ is supplied to the heater 131 in response to at least one puff occurring after a puff(s) corresponding to the first set number N₁.

When the third elapsed time T_{count3} is determined to be less than the third set time T_{S3}, the aerosol generating device 10 may heat the heater 131 with the first power P₁ in operation S1650. The battery 16 of the aerosol generating device 10 may supply the first power P₁ to the heater 131.

As described above, according to at least one of the embodiments of the present disclosure, a reduction in amount of aerosol generated due to liquid leakage from a cartridge may be prevented when the cartridge for storing an aerosol generating substance is used again after a long period of non-use.

According to at least one of the embodiments of the present disclosure, as the amount of power supplied to a heater is controlled to be proportional to a time during which a cartridge is left unused, a reduction in amount of aerosol generated may be efficiently suppressed.

According to at least one of the embodiments of the present disclosure, as the amount of power for preheating a heater is controlled to be proportional to a time during which a cartridge is left unused, a reduction in amount of aerosol generated may be efficiently suppressed.

According to at least one of the embodiments of the present disclosure, as the amount of power supplied to a heater is changed or adjusted, the sense of difference or discomfort that a user may feel may be minimized.

Referring to FIGS. 1 to 17, an aerosol generating device 10 according to an aspect of the present disclosure includes: a container 220 to accommodate an aerosol generating substance; a heater 131 to heat the aerosol generating substance; a puff sensor 151 to detect a puff; and a controller 17 to control power supplied to the heater 131, wherein the controller 17 is configured to: count, based on detecting, through the puff sensor 151, a first puff and a second puff occurring after the first puff, an elapsed time from the first puff to the second puff; compare the counted elapsed time with a first set time; control, based on the elapsed time being less than the first set time, first power to be supplied to the heater 131; and control, based on the elapsed time being greater than or equal to the first set time, second power higher than the first power to be supplied to the heater 131.

According to another aspect of the present disclosure, the controller 17 may be configured to: detect, through the puff sensor 151, a puff corresponding to a first set number occurring after the second puff; control, based on the elapsed time being greater than or equal to the first set time, the second power to be supplied to the heater 131 for the puff corresponding to the first set number starting from the second puff; and control the first power to be supplied to the heater 131 in response to at least one puff occurring after the puff corresponding to the first set number.

According to another aspect of the present disclosure, the controller 17 may be configured to: control power supplied to the heater 131, for the puff corresponding to the first set number starting from the second puff, to be gradually reduced from the second power to the first power.

According to another aspect of the present disclosure, a magnitude of the second power may be set between 110% and 160% of a magnitude of the first power.

According to another aspect of the present disclosure, the controller 17 may be configured to: compare the elapsed time with a second set time greater than the first set time; control, based on the elapsed time being less than the first set time, the first power to be supplied to the heater 131; control, based on the elapsed time being greater than or equal to the first set time and less than the second set time, the second power to be supplied to the heater 131; and control, based on the elapsed time being greater than or equal to the second set time, third power higher than the second power to be supplied to the heater 131.

According to another aspect of the present disclosure, the controller 17 may be configured to: compare the elapsed time with a second set time greater than the first set time; control, based on the elapsed time being less than the first set time, the first power to be supplied to the heater 131; control, based on the elapsed time being greater than or equal to the first set time and less than the second set time, the second power to be supplied to the heater 131 in response to a puff corresponding to a first set number occurring after the second puff; and control, based on the elapsed time being greater than or equal to the second set time, the second power to be supplied to the heater 131 in response to a puff corresponding to a second set number occurring after the second puff. The second set number may be greater than the first set number.

According to another aspect of the present disclosure, the aerosol generating device 10 may further include an insertion portion 214 having an elongated space; and a stick detection sensor 152 to output a signal corresponding to a stick 400 inserted into the insertion portion 214. The controller 17 may be configured to: count, based on detecting a third puff through the puff sensor 151 and based on detecting insertion of the stick 400 through the stick insertion sensor 152, a second elapsed time from a time point at which the third puff is detected to a time point at which the insertion of the stick is detected; compare the counted second elapsed time with a third set time; control, based on the second elapsed time being less than the third set time, the first power to be supplied to the heater 131; and control, based on the second elapsed time being greater than or equal to the third set time, the second power higher than the first power to be supplied to the heater 131.

A method of operating an aerosol generating device according to an aspect of the present disclosure may include: detecting, through a puff sensor 151, a first puff and a second puff occurring after the first puff; counting an elapsed time from the first puff to the second puff; comparing the counted elapsed time with a first set time; controlling, based on the elapsed time being less than the first set time, first power to be supplied to a heater 131; and controlling, based on the elapsed time being greater than or equal to the first set time, second power higher than the first power to be supplied to the heater 131.

According to another aspect of the present disclosure, the controlling the second power to be supplied to the heater 131 may include: detecting, through the puff sensor 151, a puff corresponding to a first set number occurring after the second puff; controlling, based on the elapsed time being greater than or equal to the first set time, second power to be supplied to the heater 131 for the puff corresponding to the first set number starting from the second puff; and controlling, first power to be supplied to the heater 131 in response to at least one puff occurring after the puff corresponding to the first set number.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings, and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

What is claimed is:

1. An aerosol generating device comprising:
a container sized to receive an aerosol generating substance;
a heater configured to heat the aerosol generating substance;
a first sensor to detect a puff; and
a controller configured to:
control power supplied to the heater;
identify an elapsed time between a first puff and a second puff, based on the first sensor detecting the first puff and detecting the second puff, wherein the second puff occurs after the first puff;
compare the elapsed time with a first time threshold;
control first power to be supplied to the heater, based on the elapsed time being less than the first time threshold; and
control second power to be supplied to the heater, based on the elapsed time being greater than or equal to the first time threshold, wherein the second power is higher than the first power.

2. The aerosol generating device of claim 1, wherein the controller is further configured to:
detect, through the first sensor, a puff corresponding to a first number and occurring after the second puff;
control the second power to be supplied to the heater for the puff corresponding to the first number, based on the elapsed time being greater than or equal to the first time threshold; and
control the first power to be supplied to the heater in response to at least one puff occurring after the puff corresponding to the first number.

3. The aerosol generating device of claim 2, wherein the controller is further configured to control power supplied to the heater, for the puff corresponding to the first number, to be gradually reduced from the second power to the first power.

4. The aerosol generating device of claim 2, wherein the controller is further configured to control power supplied to the heater, for the puff corresponding to the first number, to be incrementally reduced from the second power to the first power.

5. The aerosol generating device of claim 1, wherein a magnitude of the second power is set between 110% and 160% of a magnitude of the first power.

6. The aerosol generating device of claim 1, wherein the controller is further configured to:
compare the elapsed time with a second time threshold that is greater than the first time threshold;
control the first power to be supplied to the heater, based on the elapsed time being less than the first time threshold;
control the second power to be supplied to the heater, based on the elapsed time being greater than or equal to the first time threshold and less than the second time threshold; and
control third power to be supplied to the heater, based on the elapsed time being greater than or equal to the second time threshold, wherein the third power is greater than then second power.

7. The aerosol generating device of claim 1, wherein the controller is further configured to:
compare the elapsed time with a second time threshold that is greater than the first time threshold;
control the first power to be supplied to the heater, based on the elapsed time being less than the first time threshold;
control the second power to be supplied to the heater, based on a puff corresponding to a first number occurring after the second puff and based on the elapsed time being greater than or equal to the first time threshold and less than the second time threshold; and
control the second power to be supplied to the heater, based on a puff corresponding to a second number occurring after the second puff and based on the elapsed time being greater than or equal to the second time threshold,
wherein the second number is greater than the first number.

8. The aerosol generating device of claim 1, further comprising:
an insertion portion shaped to define an elongated space; and
a stick detection sensor configured to output a signal corresponding to a stick being inserted into the insertion portion,
wherein the controller is further configured to:
identify a second elapsed time between a time point at which the third puff is detected and a time point at which the insertion of the stick is detected, based on detecting the third puff using the first sensor and based on detecting insertion of the stick using the stick detection sensor,
compare the second elapsed time with a third time threshold;
control the first power to be supplied to the heater, based on the second elapsed time being less than the third time threshold; and
control the second power to be supplied to the heater, based on the second elapsed time being greater than or equal to the third time threshold.

9. The aerosol generating device of claim 1, wherein the first sensor is a puff sensor.

10. The aerosol generating device of claim 1, wherein the first time threshold is a first set time.

11. A method for operating an aerosol generating device having a heater, the method comprising:
identifying an elapsed time between a first puff and a second puff, based on a sensor detecting the first puff and detecting the second puff, wherein the second puff occurs after the first puff;
comparing the elapsed time with a first time threshold;
controlling first power to be supplied to the heater, based on the elapsed time being less than the first time threshold; and
controlling second power to be supplied to the heater, based on the elapsed time being greater than or equal to the first time threshold, wherein the second power is higher than the first power.

12. The method of claim 11, further comprising:
detecting, through the first sensor, a puff corresponding to a first number and occurring after the second puff;
controlling the second power to be supplied to the heater for the puff corresponding to the first number, based on the elapsed time being greater than or equal to the first time threshold; and
controlling the first power to be supplied to the heater in response to at least one puff occurring after the puff corresponding to the first set number.
